(19) United States
(12) Patent Application Publication
(10) Pub. No.: US 2024/0255272 A1
(43) Pub. Date: Aug. 1, 2024

(54) METHOD FOR OPERATING A DETECTION SYSTEM, AND DETECTION SYSTEM

(71) Applicant: HELLA GmbH & Co. KGaA, Lippstadt (DE)

(72) Inventor: Henning IRLE, Lippstadt (DE)

(73) Assignee: HELLA GmbH & Co. KGaA, Lippstadt (DE)

(21) Appl. No.: 18/628,484

(22) Filed: Apr. 5, 2024

Related U.S. Application Data
(63) Continuation of application No. PCT/EP2022/075113, filed on Sep. 9, 2022.

(30) Foreign Application Priority Data
Oct. 5, 2021 (DE) 10 2021 125 758.1

(51) Int. Cl. G01B 7/315

(52) U.S. Cl. CPC G01B 7/315; G01B 2210/26

(57) ABSTRACT

A method for operating a detection system for detecting a current position or a current rotational angle of a movably mounted component. The detection system comprises at least three partially incremental motion sensors for the redundant monitoring of the movably mounted component and at least one non-volatile data store.

This nonprovisional application is a continuation of International Application No. PCT/EP2022/075113, which was filed on Sep. 9, 2022, and which claims priority to German Patent Application No. 10 2021 125 758.1, which was filed in Germany on Oct. 5, 2021, and which are both herein incorporated by reference.

### BACKGROUND OF THE INVENTION

### Field of the Invention

The present invention relates to a method for the operation of a detection system, a detection system, a computer program product and a computer-readable storage medium, which enable an accurate and/or reliable and/or error-tolerant detection or monitoring of a current position or a current angle of rotation of a movable component and, in particular, a cost-effective and/or space-saving and/or tolerance-reduced design of a motion sensor or a detection system.

### Description of the Background Art

The exact knowledge of the current angle of rotation of a rotationally mounted component or the current position of a translationally mounted, in particular linearly movable, component with respect to a reference position (zero position) plays a major role in numerous technical areas. This requires the most accurate and reliable or continuous sensory detection of the rotational angle of rotationally mounted components or the current position of translationally mounted components. In many applications, the permissible rotation angle range of a component is greater than one complete revolution or extends over several revolutions. The permissible range of motion of translationally mounted components can also vary greatly in size or extend over large distances. However, particularly large ranges of motion make a reliable, accurate and continuous detection of a current angle of rotation or a current position of a component challenging or technically complex.

The reason for this is that rotation angle sensors and/or linear displacement sensors are usually designed as incremental or semi-incremental sensors. The core idea of partially incremental sensors is that only a sub-segment of the movement (rotation or translation) that can be performed by the component can be directly detected by the corresponding sensor. This sub-segment is hereinafter referred to as the measuring segment. If the measuring segment detectable by the sensor is exceeded due to a progressive movement of the component to be monitored, an increment counter assigned to the sensor is incremented or decremented and the measuring segment is then traversed again. Inside the measuring segment, the current value of a rotation angle or a linear displacement can be determined on the basis of the output signal of the sensor, which is proportional to a corresponding rotation or a translational, in particular linear, displacement of the movable component within the measuring segment.

In relation to a rotation angle sensor, this means, for example, that only a partial angle segment (<360°) of a full rotation (360°) can be continuously detected by the sensor. In other words, if the component rotationally mounted and monitored by the sensor is rotated within the sub-angle segment, the angle of rotation can be read from the output signal of the sensor, since the output signal is proportional to the rotational angle of the rotationally mounted component within the sub-angle segment. If, on the other hand, the angle of rotation of the rotationally mounted component exceeds an upper or lower limit value of the sub-angle segment, an increment counter is incremented or decremented and the sub-angle segment is traversed again when the rotatory component rotates further. Incrementing or decrementing of the increment counter is carried out depending on whether the sub-angle segment falls below or reaches an upper or lower limit value. For example, it may be provided that when an upper limit value is reached or exceeded, the increment counter is incremented and when the increment counter reaches or falls below a lower limit value, the increment counter is decremented. Thus, the rotation angle of the component, which is rotationally mounted and monitored by a partially incremental rotation angle sensor, is always determined by the current value or counter reading of the increment counter multiplied by the angular range of the sub-angle segment in sum with the angle of rotation currently recorded or readable in the sub-angle segment. Accordingly, this procedure can be applied to the detection of translational, especially linear, displacements of a component by means of a partially incremental motion sensor.

Accordingly, in addition to the current output signal of the motion sensor, which represents a current angle of rotation or a current position in the measuring segment monitored by the motion sensor, there must always be precise knowledge of the counter reading of the increment counter assigned to the motion sensor, which represents the measurement history, in order to ensure a reliable statement about the total angle of rotation detected by the motion sensor of a rotationally mounted or moving component or the total displacement of a translationally, in particular linearly, mounted or movable component detected by the motion sensor. If this additional information or the counter reading of the increment counter is lost, or if the counter reading of the increment counter is subject to errors, no reliable statement can be made about the current angle of rotation or the current position of a movable component on the basis of evaluating the output signal of a motion sensor alone.

This can have critical implications, especially for safety-relevant systems. An example of this is the monitoring or detecting of the current steering angle of a vehicle, especially in an automobile. In particular, vehicles that use steer-by-wire systems and where there is no mechanical connection between the steering wheel and the steered wheels require accurate and reliable detection of the current steering angle, as the vehicle's steered wheels are aligned solely on the basis of the sensory angle of rotation of the steering wheel. A discrepancy between the sensorially detected current steering angle of the wheels and the actual steering angle of the wheels can therefore lead to situations that significantly endanger the safe operation of the vehicle and/or the health of the driver or other occupants.

Alternative methods for detecting an angle of rotation or a current position of a movable component, which do not require the use of an increment counter, are known from the state of the art. For example, the rotational movement of a rotationally mounted component for the sensory detection of at least one gearbox can be reduced in such a way that several complete revolutions of a rotationally mounted component or the entire permissible rotation angle range of a rotationally mounted component can be mapped or detected in the measuring segment (<360°) of a rotation angle sensor. In the context of the present invention, a complete rotation of a rotationally mounted component corresponds to a rotation by 360° (angular degree). The reduction of translational, especially linear, movements of translationally supported components can also be provided accordingly. Depending on the application and the permissible range of motion of the rotationally or translationally mounted component, these gearboxes must be individually designed, cause additional weight, require additional installation space, are subject to wear and aging, require additional material and development costs, and also entail additional tolerances that must be taken into account in the value acquired by the motion sensor. Since a multi-lane or redundant acquisition of a single measured value by independent sensors is necessary or at least advisable, especially in safety-relevant systems, the disadvantages mentioned above come to the fore all the more in such sensory detection of safety-relevant parameters.

### SUMMARY OF THE INVENTION

It is therefore an object of the present invention to overcome at least partially at least one of the disadvantages described above. In particular, it is an object of the invention to provide a method for the operation of a detection system, a detection system, a computer program product and a computer-readable storage medium, which enable an accurate and/or reliable and/or error-tolerant detection or monitoring of a current position or a current angle of rotation of a movable component and, in particular, a cost-effective and/or space-saving and/or tolerance-reduced design of a motion sensor or a detection system.

The preceding object is achieved by a method for operating a detection device; by a detection system; by a vehicle; by a computer program product and by a computer-readable storage medium. In this context, features and details described in connection with the method of the invention are, of course, also valid in connection with the inventive detection system and/or in connection with the inventive vehicle and/or in connection with the inventive computer program product and/or in connection with the inventive computer-readable storage medium, so that reciprocal reference is or can always be made with regard to the disclosure of the individual aspects of the invention.

According to an example of the invention, a method is provided for operating at least one detection system that is provided for the detection of a, for example, current, position and/or an, in particular current, angle of rotation of a movable component, the detection system comprising at least three, in particular partially incremental, motion sensors for independent and/or redundant monitoring of the movable component, wherein at least the following steps are carried out for each motion sensor: (a) Evaluating an output signal of the respective motion sensor and the output signal detecting the output signal at least falling below or reaching a lower limit value and exceeding or reaching an upper limit value, wherein the lower limit value and the upper limit value demarcate a measuring segment detectable by the motion sensor; (b) Incrementing or decrementing an increment counter assigned to the respective motion sensor at least if the output signal has detected that it has fallen below or reached the lower limit value or exceeded or reached the upper limit value, wherein, the following step is additionally performed: (c) Retrieving and comparing the counter readings of the increment counters assigned to the motion sensors in order to detect an erroneous counter reading of at least one increment counter.

In other words, a method for operating a detection system is proposed, wherein the detection system is used to detect a current angle of rotation and/or a current position of a movable, preferably rotational or translational component. For this purpose, the detection system comprises at least three, in particular partially incremental, motion sensors for independent and/or redundant and/or multi-channel monitoring or detection of the current angle of rotation and/or the current position of the movable component. The use of at least three motion sensors offers the advantage that in the event an erroneous measured value of a motion sensor is detected, not only the mere presence of an error itself can be determined, but also a conclusion is made possible as to which of the motion sensors is faulty, which in turn enables the performance of a corresponding error correction.

It may be provided within the scope of the invention that all motion sensors of the detection system are designed to monitor a similar or the same movement of the movable component. For example, it may be provided that all motion sensors are designed as rotation angle sensors for monitoring or detecting a current angle of rotation of the movable, especially rotational, component. It may also be provided that all motion sensors are designed as displacement sensors, in particular linear displacement sensors, for monitoring or detecting a current position of the movable, in particular translational or linear, component.

The movable component can preferably be a rotationally mounted component. The movable component can also be a translationally mounted component, wherein the bearing is designed in such a way that a linear translational movement can be carried out by means of the component.

At least one motion sensor can be designed as a partially incremental motion sensor. A partially incremental motion sensor is designed to detect a movement, in particular a rotation or a translation, preferably linear, of a movable component via a measuring segment, in particular continuously or quasi-continuously and/or time-resolved, wherein in particular an output signal output by the motion sensor is proportional to the movement of the movable component detected within the measuring segment. Thus, the output signal can be used to determine a current position or a current angle of rotation of the movable component within the measuring segment detectable by the motion sensor. At least if the movement of the component movably supported by the partially incrementally motion sensor, in particular in its extent, exceeds or falls below the upper or lower limit value of the measuring segment, at least one increment counter assigned to the motion sensor is incremented or decremented and the measuring segment of the motion sensor is traversed again accordingly in the event of a progressive movement of the movable component. In this case, the increment counter is incremented or decremented depending on whether it falls below and/or reaches the lower limit value or exceeds and/or reaches the upper limit value of the measuring segment detectable by the motion sensor. For example, it may be provided that when an upper limit value is reached or exceeded, the increment counter is incremented and when a lower limit value is reached or fallen below, the increment counter is decremented. Thus, with regard to the monitoring of a rotationally mounted component by at least one rotation angle sensor, it may be provided that when the rotationally mounted component is rotated clockwise, the measuring segment of the rotation angle sensor is traversed by the lower limit value of the measuring segment in the direction of the upper limit value of the measuring segment and that the increment counter assigned to the rotation angle sensor is incremented when exceeding or reaching the upper limit value with a value of +1. The counter reading is therefore increased by the value of one. Accordingly, it may also be provided that when the rotationally mounted component is rotated counterclockwise, the measuring segment is traversed in the opposite direction or from the upper limit value in the direction of the lower limit and if the lower limit value of the measuring segment falls below or reaches the limit value, the increment counter assigned to the rotation angle sensor is decremented with a value of −1. The counter reading is therefore reduced by 1. A correspondingly reversed procedure with regard to the incrementing and decrementing of at least one increment counter is also conceivable in principle within the scope of the invention. This can be applied analogously to the detection of translational movements by appropriate displacement sensors.

It may be provided within the scope of the invention that at least two, preferably all motion sensors of a detection system are designed for detection in the same measuring segment or that the range of motion spanned by the measuring segment, in particular the angular range or, preferably, the linear displacement range, is the same for at least two motion sensors, in particular all motion sensors. This has the advantage of being particularly easy and straightforward to compare the counter readings of the increment counters assigned to the motion sensors.

It is possible that, with regard to at least one motion sensor designed as a rotation angle sensor, the measuring segment covers a rotation angle range from 0° to less than 360° (angular degree), in particular from 0° to less than or equal to 240° (angular degree), preferably from 0° to less than or equal to 180° (angular degree), especially preferably from 0° to less than or equal to 120° (angular degree). If the measuring segment extends, e.g., from 0° to 120°, the measuring range covered by the measuring segment of the motion sensor is 120° (angular degrees).

Preferably, the current position detected by a partially incremental motion sensor or the current angle of rotation of a movable component detected by the partially incrementally motion sensor can be calculated by multiplying the counter reading of the increment counter assigned to the motion sensor by the measuring range (e.g., of a total detectable total length in the measuring segment or a total detectable angular range in the measuring segment) covered by the measuring segment of the motion sensor and a subsequent addition with the value readable or determinable from the output signal of the motion sensor within the measuring segment detectable by the motion sensor. The measuring range covered by the measuring segment of the motion sensor can be, e.g., a total displacement covered by the measuring segment or a total angular range covered by the measuring segment. It is also conceivable that prior to multiplying the counter reading by the measuring range of the measuring segment, the counter reading is changed or corrected by previous arithmetic operations, in particular at least one division without remainder. This may be necessary in particular if the increment counter is not only incremented or decremented if the value exceeds and/or reaches or falls below and/or reaches the upper or lower limit value of the measuring segment, but also when the value exceeds and/or reaches or falls below and/or reaches at least one additional limit value within the measuring segment or between the upper and lower limit values.

In step a) of the method according to the invention, the output signal of at least one motion sensor or the output signals of all motion sensors are evaluated and the output signal detects whether the value at least falls below or reaches a lower limit value and whether it exceeds or reaches an upper limit value, wherein the lower limit value and the upper limit value demarcate a measuring segment detectable by the motion sensor. The aim of the detection is to determine whether it is necessary to increment or decrement the increment counter assigned to the motion sensor and in which direction the increment counter must be incremented or decremented. It may be provided that step a) is carried out continuously or quasi continuously. The evaluation and detection in step a) is therefore necessary in order to ensure the at least one motion sensor correctly detects the current angle of rotation or the current position of a movable component, even if the angle of rotation of the movable component or the, preferably linear, displacement covered by the movable component is greater than the measuring segment detectable by the motion sensor.

It may be provided within the scope of the invention that the output signal of at least one motion sensor has or can have a sawtooth structure or a sawtooth-shaped profile, at least in sections, wherein in particular one saw tooth in each case indicates the complete or one-time traversal through the measuring segment detectable by the motion sensor. In other words, it may be provided that, in the event of a progressive movement of the movable component monitored by the motion sensor over a range of motion, which is a multiple of, in particular twice, the range of motion covered by the measuring segment of the motion sensor, the output signal of at least one motion sensor has several successive saw teeth, each of which characterizing the complete or one-time traversal of the measuring segment detectable by the motion sensor.

It may be provided that, in particular when the output signal is applied via the total movement detected by the motion sensor and an increment counter assigned to the motion sensor (translational or linear displacement or angle of rotation), at least one saw tooth has a flank inclined to a vertical direction and a flank parallel or substantially parallel to the vertical direction. In other words, it may be provided that at least one saw tooth has a flank with an infinitely large or quasi-infinitely large slope and a flank with a finitely large slope, wherein the slope represents the change in the output signal in relation to the change in the motion (linear displacement or angle of rotation) detected by the motion sensor. It may be provided that the flank inclined to the vertical direction characterizes a continuous rise or fall of the output signal of the motion sensor while traversing the measuring segment detectable by the motion sensor. It may also be provided that the flank parallel or substantially parallel to the vertical direction characterizes the transition from one (e.g., first) passage of the measuring segment detectable by the motion sensor to another (e.g., second) passage of the measuring segment detectable by the motion sensor and/or a necessary incrementing or decrementing of the increment counter assigned to the motion sensor. For example, it may be provided that when the output signal detects the value falling below or reaching a lower limit value and/or exceeding or reaching an upper limit value in step a), it includes the detection of at least one vertical or essentially vertical flank of the output signal.

It may be provided that step (a) also includes the detection of at least one intermediate limit value, preferably at least two intermediate limit values, which fall below and/or are exceeded and/or reached.

In step b) of the inventive method, at least one increment counter assigned to a motion sensor is incremented or decremented. Incrementing or decrementing is carried out at least when it has been detected that the lower limit value has been exceeded or reached and/or that the upper limit value has been exceeded or reached, in particular in step (a). In this case, it may be provided that incrementing is carried out when the upper limit value is reached or exceeded, and decrementing is carried out if the lower limit is reached or undercut. Consequently, this ensures that the current angle of rotation or the current position of a movable component monitored by the motion sensor is or cannot only be determined by the current value of the output signal of the motion sensor, but also by taking into account the counter reading of the increment counter assigned to the motion sensor and thus taking into account a single or multiple passage through the measuring segment detectable by the motion sensor that has already taken place in the past.

Step c) of the inventive method involves retrieving and comparing the counter readings of the increment counters assigned to the motion sensors of the detection system in order to detect an erroneous counter reading of at least one increment counter. This makes it easy and quick to detect a potentially faulty motion sensor or counter reading of an increment counter assigned to the motion sensor. On the basis of the detected error, decisions can be made for the further operation of a higher-level system, in particular a vehicle. For example, a decision can be made as to whether the safe operation of the system, in particular the vehicle, can continue to be guaranteed, or whether the detected error can be corrected and a reliable and accurate detection of the current angle of rotation or the current position of a movable component can be further guaranteed by the detection system. Since at least three motion sensors are included by the detection system and thus at least three counter readings of increment counters assigned to different motion sensors are compared, the comparison not only allows the mere presence of an error to be detected, but also to make a statement about which of the motion sensors or the increment counters assigned to the motion sensors is error-prone. Accordingly, the counter reading of the relevant increment counter that has been identified as incorrect can be corrected and the rotation angle or position monitoring by the detection system can be continued consistently.

It may also be provided that at least step (c) is carried out cyclically or repeatedly, in particular at fixed intervals. This achieves the advantages of continuous monitoring or detection of the correct functioning of the detection system and rapid error detection.

All in all, the advantage of this inventive method is that even when using partially incremental motion sensors, a reliable and accurate statement can be made about the current angle of rotation or the current position of a movable, in particular rotationally or translationally mounted component, since a loss of counter readings of the increment counters assigned to the motion sensors is effectively avoided and also possible faulty counter readings can be recognized and corrected. Thus, by means of the inventive method, partially incrementally motion sensors can also be used in safety-relevant systems without sacrificing safety and/or prediction accuracy. Since this eliminates the need for additional reduction gears to detect large rotation angle ranges or distances, the complexity, installation space and costs of a detection system for detecting a current angle of rotation or the current position of a movable component and ultimately also the tolerances to be taken into account when detecting the current angle of rotation or the current position can be effectively reduced.

It may be provided that the movable component is a steering wheel with rotary bearings, in particular, or at least a part of an actuator for adjusting the steering angle of the front or rear wheels of a vehicle. The movable component may also be a component connected to a steering wheel or steering system, which is in particular rotationally mounted, wherein a rotational movement of the steering wheel or steering system, which are preferably equal, is transferred to the movable component. In the context of the present invention, a vehicle may preferably be a car, a truck or an agricultural vehicle, in particular a tractor, a combine harvester or an excavator. Preferably, the vehicle can be an electric vehicle or a fully electric vehicle or a hybrid electric vehicle.

It is conceivable in the context of the invention that at least one step of an inventive method is repeated, in particular cyclically, and/or continuously or quasi continuously. It is also conceivable that at least two steps of an inventive method, at least in part, are carried out simultaneously. Furthermore, it may be provided that an inventive method is a computer-implemented method.

In the present case, a quasi-continuous execution can mean a repeated execution of a step at short intervals. In particular, a quasi-continuous execution may include an execution frequency of at least 100 Hz, in particular at least 1 kHz, particularly preferably at least 100 or at least 200 kHz.

It may also be provided within the scope of the invention that at least two motion sensors of a detection system are arranged on a common component, in particular a printed circuit board, or are part of a common assembly, in particular a control unit. It may also be provided that at least two motion sensors of a detection system are arranged on different components, in particular different printed circuit boards, or are part of different assemblies, in particular different control units. In particular, however, it is conceivable that all motion sensors of a detection system are used to monitor a movable component, regardless of its arrangement on or in common or different components or assemblies.

It may be provided within the scope of the invention that the detection system comprises at least one non-volatile data memory in order to be able to permanently save or store at least one motion sensor data record and/or at least one error data record. At least one non-volatile memory can be designed as a flash memory. The use of a non-volatile data memory offers the advantage that the data are preserved even if the power supply to the detection system is lost. A loss of power supply can be unplanned, e.g., in the context of a sudden voltage reduction (brown-out), but also when the detection system is deliberately switched off. This can happen, e.g., when the detection system is used in a vehicle and the vehicle is switched off. By storing at least one motion sensor data record and/or error data record on a non-volatile data memory, the stored data can be retrieved from the data memory after the power supply has been restored and be used for the initiation of at least one increment counter assigned to a motion sensor. The information about the counter reading of an increment counter assigned to the motion sensor, which was determined in the past with reference to a motion sensor, is thus not lost, which means that reliable monitoring or detection of the current position or the current angle of rotation of a movable component can be carried out by at least one motion sensor. It may also be provided within the scope of the invention that at least two, in particular several, non-volatile data memories are included. This has the advantage that redundancy can be achieved with regard to the stored motion sensor data records. In this way, the detection system can ensure reliable detection of a rotation angle or position of a movable component even if a non-volatile data memory of the detection system is functionally impaired. It may be provided that a data memory is a main memory on which motion sensor data records and/or error data records are saved or stored, and at least one data memory is a backup memory. In addition, it may be provided that a backup of the main memory is carried out at least at fixed intervals, wherein all data records stored in the main memory are copied to the backup memory.

It may also be provided within the scope of the invention that in addition, in particular for each motion sensor, at least the following step is carried out, in particular as step d): Retrieving the counter reading of the increment counter and storing at least one motion sensor data record in a non-volatile data memory, wherein the motion sensor data record includes at least the current counter reading of the increment counter and a motion sensor detection of the respective motion sensor.

For ease of reference, the above method step of retrieving an increment counter reading and storing a motion sensor data record is hereinafter referred to as step d). In other words, it may be provided that at least one motion sensor data record is stored in at least one non-volatile memory of the detection system. This has the advantage that the motion sensor data record is permanently backed up and is retained within the detection system even in the event of a power supply interruption. In this way, when the power supply is restored, the measurement history of one or more motion sensors can be accessed and the current angle of rotation or the current position of a movable component monitored by the motion sensor(s) can be determined or further acquired. The motion sensor data record may include at least the current counter reading of an increment counter assigned or assignable to a motion sensor and/or a motion sensor identifier of the motion sensor and/or a timestamp. The use of a timestamp makes it possible to always identify the most up-to-date motion sensor data record in the event that several motion sensor data records with an identical motion sensor identifier have been stored in the non-volatile data memory, and also allows for traceability over time of the increments or decrements of an associated increment counter with respect to a motion sensor, which can simplify a root cause analysis in the event of an identified error. However, it may also be provided that for each motion sensor identifier only one motion sensor data record exists and/or is stored or saved to the non-volatile data memory. For this purpose, on the basis of a new motion sensor data record to be stored, a check can be carried out as to whether a motion sensor data record with the corresponding or the same motion sensor identifier already exists in the non-volatile data memory. If this is the case, the motion sensor data record in question can be deleted or overwritten in the non-volatile data memory and the new motion sensor data record can be stored or saved in the non-volatile data memory.

It may be provided that the motion sensor identifier is specific to the motion sensor(s). In other words, it may be provided that the motion sensor identifier can or is capable of unambiguously assigning the counter reading of an increment counter contained in the motion sensor data record to a motion sensor, in particular a specific one. In this way, motion sensor data records stored or saved in the data memory can always be assigned to the associated motion sensors and a continuous incrementing or decrementing of an increment counter assigned to the motion sensor can be ensured, which makes it possible to detect the current angle of rotation or the current position of a movable component monitored by the motion sensor in a reliable and accurate manner. At least one motion sensor identifier can be a numeric, alphabetic or alphanumeric string and contain at least 10, preferably at least 20 characters.

It may also be provided within the scope of the invention that at least two motion sensors, in particular all motion sensors, of the detection system are operated with different, in particular independent, energy sources or receive their energy supply from different, in particular independent, energy sources. This can increase the reliability of the detection system. The energy sources can be energy sources of a vehicle. in particular from an all-electric or hybrid electric vehicle.

Also, it may be provided within the scope of the invention that at least one energy source is one of the following energy sources: a 12V battery, especially from an all-electric or hybrid-electric vehicle; a high-voltage battery, in particular from an all-electric or hybrid-electric vehicle; a backup capacitor, in particular of an all-electric or hybrid-electric vehicle; a supercapacitor, in particular from an all-electric or hybrid-electric vehicle; a backup battery, in particular in the form of a coin cell, a lithium battery or a rechargeable battery, in particular lithium batteries; and/or a DC voltage converter, especially of an all-electric or hybrid-electric vehicle.

It may also be provided within the scope of the invention that at least one of the following steps is carried out additionally, in particular in step c): Carrying out at least one majority decision, in particular a 2-out-of-3 decision, for the identification of at least one erroneous counter reading, in particular if at least one counter reading differs from at least one other counter reading, Correcting an erroneous counter reading of at least one increment counter, Storing at least one error data record in the non-volatile data memory, provided that at least one erroneous counter reading has been identified.

In other words, it may be provided that the determination or detection of an erroneous counter reading is feasible on the basis of a majority decision. For this purpose, a comparison of the counter readings is first carried out to check whether all counter readings are the same. If this is the case, it is assumed that there is no error in the detection system and/or no motion sensor or counter reading of an increment counter is faulty. If, on the other hand, at least one counter reading of one increment counter differs from the counter reading of at least one other increment counter, it is assumed that the counter reading of at least one increment counter is faulty. The erroneous counter reading can be identified on the basis of a majority decision, assuming that if a majority of the compared counter readings have the same value, this value is the correct value. Counter readings that deviate from this value identified as correct can be identified as faulty. With regard to the implementation of a 2-out-of-3 decision, this means that if two counter readings have an identical value and one counter reading has a value that differs from that value, it is assumed that the two counter readings with an identical value display the correct value and that the counter reading with the different value is faulty. If the detection system comprises more than three motion sensors, the majority decision can also be carried out differently. If there are four motion sensors, the majority decision can be carried out as a 3-out-of-4 decision. In the case of five motion sensors, the majority decision can be carried out as a 4-out-of-5 decision. By increasing the number of motion sensors and carrying out corresponding majority decisions, an even more reliable detection of individual errors can be realized. When using three motion sensors and carrying out a 2-out-of-3 decision, the advantage of a simple and cost-effective setup of the detection system becomes apparent.

It is also conceivable in the context of a majority decision, in particular where more than three, in particular partially incremental, motion sensors are used in the detection system, that in order to carry out the majority decision or to detect at least one erroneous counter reading, the motion sensors or the increment counters assigned to the motion sensors are divided into at least two groups, in particular in a random or quasi-random manner, and in particular in relation to each of the groups, a majority decision is carried out when evaluating the respective counter readings for the detection of at least one erroneous counter reading. It may be provided that the division into, in particular random or quasi-random, groups is carried out again each time step (c) is carried out. It can further be provided for each group to comprise at least three or three, in particular at least four or four, and particularly preferably at least five or five motion sensors or increment counters assigned to the motion sensors. The number of motion sensors or increment counters can be adapted to the type of majority decision to be carried out. It may be provided that each motion sensor or increment counter is assigned to at least one group. It may also be provided that at least one motion sensor or increment counter is assigned to at least two groups. This is necessary, e.g., if, when there are five motion sensors, two groups of three motion sensors each or three increment counters each assigned to the motion sensors are formed in order to make a 2-out-of-3 decision in both groups with regard to the counter readings of the increment counters assigned to the motion sensors, since the number of motion sensors or increment counters is not sufficient to form two groups, with each motion sensor or increment counter being assigned to only one group. As a result, an even more reliable detection of at least one erroneous counter reading of an increment counter assigned to a motion sensor can be realized. It may be provided that each group has an equal number of increment counters or motion sensors.

It may be provided that at least one of the following steps is performed, preferably in step (c), especially if the detection system includes more than three, preferably semi-incremental, motion sensors: Dividing the motion sensors and/or the increment counters assigned to the motion sensors into at least two groups, comprising in particular at least three motion sensors and/or increment counters, wherein each motion sensor and/or increment counter is assigned to at least one group; Carrying out a majority decision, in particular a 2-out-of-3 decision, for each group in order to identify at least one erroneous counter reading, in particular if at least one counter reading differs from at least one other counter reading, Correcting a counter reading of at least one increment counter, Storing at least one error data record in the non-volatile memory.

Furthermore, it may be provided within the scope of the invention that, following the execution of at least one majority decision, a correction of at least one counter reading identified as faulty or erroneous is carried out by setting or correcting the counter reading identified as faulty by the majority decision to the counter reading identified as correct by the majority decision.

Furthermore, it is possible that if at least one faulty counter reading has been detected, at least one error data record is stored or saved in at least one non-volatile data memory. This makes it possible to track the error history within the detection system at a later date. It will also be possible to evaluate the error data records with regard to the frequency of occurrence of an error in a specific motion sensor or in the associated increment counter. In this way, it can be determined whether a detected error in a specific motion sensor has already been noted frequently in the past, which indicates a systemic error and requires a corresponding recheck of the detection system or the motion sensor. It may be provided that at least one error data record may include at least one motion sensor identifier and/or a counter reading of at least one increment counter identified as erroneous and/or at least one correction value and/or at least one timestamp. The correction value can be the value to which at least one counter reading of at least one increment counter that has been identified as erroneous has been corrected. The motion sensor identifier can be specific to the motion sensor whose increment counter has been corrected or needs to be corrected. It may be provided that for each error identified in relation to a motion sensor or to the increment counter associated with the motion sensor and/or a corresponding correction, an individual error data record is created or stored in the non-volatile data memory.

Furthermore, it is possible that in addition, in particular for each motion sensor and/or prior to step a), at least the following step is performed: initializing an increment counter with an initial counter reading and assigning the increment counter to the respective motion sensor, in particular using at least one motion sensor data record.

In other words, it may be provided that at least one increment counter is initialized and that the increment counter is assigned to a specific motion sensor. In particular, at least one increment counter is initialized and assigned to each motion sensor. The assignment can be made via a motion sensor identifier, whereby a clear connection between the increment counter and the motion sensor can be established. Initialization may also involve setting the counter reading of the increment counter to an initial value. Preferably, a motion sensor data record stored in the non-volatile data memory can be used in order to correctly record the increments or decrements carried out in the past with regard to the motion sensor when setting the initial value and to be able to continue them accordingly. This ensures that the current position or current angle of rotation of a movable component can always be correctly recorded or read out and that no relevant information from the past is lost. Retrieval of the motion sensor data record can be done by using a motion sensor identifier of the motion sensor, so that a motion sensor data record associated with the motion sensor identifier or motion sensor can be identified. In this way, it can be ensured that the initialization of the increment counter is carried out with the correct value related to the corresponding motion sensor. If there is no motion sensor data record with the motion sensor identifier contained or stored in the non-volatile data memory, the initial value can be set to zero. This may be required, e.g., for a first-time launch or use of the detection system.

In particular, it may be provided for at least one of the following steps to be carried out in the context of the initialization of at least one increment counter and/or the assignment of at least one increment counter to a motion sensor: Assigning a motion sensor identifier of the respective motion sensor to the increment counter; Identifying at least one motion sensor data record, in particular the most current or most recent in time, in the non-volatile memory, preferably on the basis of the motion sensor identifier of the respective motion sensor; Retrieving an increment counter reading from the motion sensor data record and setting the increment counter reading of the increment counter to the value of the increment counter reading retrieved from the motion sensor data record; and/or Setting the increment counter reading to zero if no motion sensor record could be identified from the motion sensor identifier of the respective motion sensor.

Furthermore, it is conceivable in the context of the invention that step (d) is carried out at least at fixed time intervals and/or at least after an execution of step (b) and/or at least in the event of loss of a supply voltage of at least one motion sensor and/or at least after completion of an initialization of at least one increment counter.

In other words, it may be provided that step (d) of an inventive method is carried out at least at fixed intervals. The time interval between two executions of step (d) may be less than 1 minute, in particular less than 30 seconds, preferably less than 10 seconds, especially preferably less than 1 second. By repeatedly performing step (d) over time, the probability of data loss in regard to the counter reading of one or more increment counters can be reduced.

Also, or alternatively, the execution of step d) may take place at least after each execution of step b). In other words, step (d) can at least be executed whenever at least one increment counter associated with a motion sensor has been incremented or decremented. This ensures that any changes to an increment counter are immediately stored in the non-volatile data memory. This can further reduce the loss of information in respect of the counter reading of at least one increment counter.

Also, or alternatively, step d) can be carried out at least in the event of a loss of a supply voltage and/or power supply of at least one motion sensor. This has the advantage that in the event of a loss of a supply voltage or power supply, a loss of information can be effectively avoided and safe and correct operation of the detection system can be resumed after the voltage supply or power supply has been restored. In this context, it may be provided that the execution of step d) is preceded by a detection of at least a temporary loss of supply voltage or power supply (brown-out).

It may be provided that in the context of the inventive method, the following step is additionally carried out: Monitoring, in particular continuous monitoring, of the supply voltage of at least one motion sensor, in particular all motion sensors, by at least one brown-out detector to detect at least a temporary loss of the supply voltage of the motion sensor.

It may be provided that the monitoring of the supply voltage is carried out for all motion sensors. In this context, it may be provided that the detection system includes at least one brown-out detector or that at least one brown-out detector is assigned or assignable to each motion sensor. It may also be provided that at least one brown-out detector monitors the supply voltage of at least two motion sensors. In other words, it may be provided that at least one motion sensor, in particular all motion sensors, are, in particular, continuously monitored by at least one detector for the detection of a drop or loss of supply voltage or power supply (brown-out detector). For this purpose, the detection system can have at least one brown-out detector to monitor the voltage supply or power supply of at least one motion sensor or have at least one brown-out detector by which the supply voltage of at least one motion sensor can be monitored or detected, preferably continuously or quasi-continuously, and/or a loss of supply voltage can be detected. The detector may be at least partially designed as an electrical circuit (BOD circuit, brown-out-detection circuit). A detection of a loss of supply voltage can at least include detecting or recording a drop in the supply voltage to below a limit value.

Also, or alternatively, step (d) may be carried out at least after completion of an initialization and/or assignment of at least one increment counter. This ensures that a motion sensor data record is stored in the non-volatile memory after initialization or assignment of an increment counter and is used for subsequent initializations.

Further, it may be provided within the scope of the present invention that step b) is additionally carried out at least when the output signal exceeds and/or undercuts at least one intermediate limit value, wherein the intermediate limit value is less than the upper limit value and greater than the lower limit value. In other words, it may be provided that the incrementing or decrementing of an integral counter assigned to a motion sensor is carried out not only when the upper and/or lower limit value of the measuring segment detectable by the motion sensor is undercut or exceeded, but also when at least one or always when an intermediate limit value disposed or lying between the upper and lower limit values is exceeded and/or undercut. Several, in particular at least two or exactly two, intermediate limit values may be provided. Also, or alternatively, it may be provided that the measuring segment of the motion sensor or the area between the upper and lower limit values is divided into segments of equal size by at least one intermediate limit value, or that the upper limit value, the lower limit value and at least one intermediate limit value have equidistant distances. Such a counting method can create the prerequisite for a more precise evaluation of the motion sensor or the counter reading of the increment counter assigned to the motion sensor. With regard to a sawtooth-shaped output signal of a motion sensor, the problem arises that in an especially infinitesimal small area around the vertical or essentially vertical flank of a sawtooth, there may be two counter readings of an increment counter, which, however, with additional consideration of the current output signal of the motion sensor, represent an identical current angle of rotation or an identical current position of the movable component. When comparing the counter readings, this can lead to unintentional identification of deviations. It is therefore necessary to ensure that a first counter reading in conjunction with an output signal from the motion sensor, which is equal or quasi equal to the upper limit value and a second counter reading increased by one as compared to the first counter reading, in conjunction with an output signal from the motion sensor, which is equal or quasi equal to the lower limit value, can be identified as equivalent counter readings. Such identification can be realized by the counting method described above. In particular, it may be provided for a first and a second intermediate limit value to be provided, preferably the first intermediate limit value being lower than the second intermediate limit value and in particular the first and second intermediate limit values being greater than the lower limit value and lower than the upper limit value.

It may be provided within the scope of the invention that in step (c), preferably prior to comparing the counter readings, at least one arithmetic operation is applied to at least one counter reading of an increment counter, in particular to all counter readings, thereby determining a corrected value of the counter reading of the increment counter. It may also be provided that the subsequent comparison of counter readings does not use the counter reading retrieved, but instead the result of the arithmetic operation or operations applied to the counter reading, or the corrected counter reading. In other words, it may be provided that in step (c), preferably prior to comparing the counter readings, the counter reading of at least one increment counter is corrected. Preferably, it may be provided that at least the following arithmetic operations are performed to correct the counter reading: Calculating a dividend by adding one to the counter reading, Calculating a divisor by adding one to the number of intermediate limit values, Performing a division with no remainder using the dividend and divisor, in particular the result of the division being the corrected counter reading.

In other words, the counter reading is first increased by one and then a division is carried out, with the counter reading increased by one being used as dividend and the number of intermediate limit values increased by one being used as divisor. For example, if the number of intermediate limit values is two, the divisor has a value of three. If the counter reading is, e.g., three, the dividend has a value of 4. In this example, the result of division without remainder or the corrected counter reading would be one. The result is a value suitable for the comparison of two increment counters, which takes into account the previously described problem of a first counter reading in connection with an output signal from the motion sensor, which is equal or quasi equal to the upper limit value, and a second counter reading increased by one as compared to the first counter reading in connection with an output signal from the motion sensor, which is equal or quasi equal to the lower limit value. In this way, incorrect identification of erroneous counter readings or incorrect detection of error states can be effectively avoided.

Furthermore, it is conceivable in the context of the invention that the following step is performed, in particular prior to step (a): Aligning the phase position of at least two output signals or the phase position of all output signals.

It may be provided that the alignment is carried out on the basis of a spatial offset of the motion sensors in the detection system, which is known in particular. As a result, a more efficient evaluation of the output signals can be realized.

Preferably, it can be provided within the scope of the invention that at least one increment counter is trained in software technology or implemented as software. Also, or alternatively, at least one increment counter may be physically trained.

It may be provided within the scope of the invention that the output signal of at least one motion sensor is one, preferably variable, electrical voltage or current, wherein preferably the output signal is proportional to the measured value (angle of rotation or displacement) currently recorded by the motion sensor in the measuring segment detectable by the motion sensor.

It is also conceivable in the context of the invention that the detection system is an inventive detection system and/or is designed according to any one of claims 8 to 12.

Furthermore, the above object is achieved by an inventive detection system comprising at least three, in particular partially incremental, motion sensors for the redundant detection of the, in particular current, angle of rotation and/or the position of a movable, in particular rotational or translational component, and at least one non-volatile data memory, wherein the detection system is operated or operable according to an inventive method, in particular according to a method according to any one of claims 1 to 7. With regard to the detection system, there are the same advantages as those already described with regard to the inventive method.

Furthermore, it may be provided within the scope of the invention that at least two motion sensors, in particular all motion sensors, of the detection system can be operated by different or independent energy sources. At least one energy source can preferably be one of the following: a 12V battery, especially from an all-electric or hybrid-electric vehicle; a back-up battery, in particular in the form of a coin cell, a lithium battery or a rechargeable battery, in particular lithium batteries; a high-voltage battery, in particular from an all-electric or hybrid-electric vehicle; a backup capacitor, in particular from an all-electric or hybrid-electric vehicle; a supercapacitor, in particular from an all-electric or hybrid-electric vehicle; and/or a DC voltage converter, especially from an all-electric or hybrid-electric vehicle.

This has the advantage of realizing a higher reliability of the detection system.

It is also conceivable within the scope of the invention that at least two motion sensors have a spatial offset, in particular so that a mutual influence of the output signals of the motion sensors is reduced or excluded. This has the advantage that an error event, which, e.g., causes an erroneous counter reading of an increment counter assigned to a motion sensor, only affects one motion sensor or the increment counter assigned to the motion sensor, but not the other motion sensors. This creates additional security that error events can also be reliably detected as such. It may also be provided that a phase shift of the output signals of the motion sensors caused by the spatial offset is recalculated prior to an evaluation of the output signals, in particular in order to align the phase position of the output signals.

It may be provided within the scope of the invention that at least one motion sensor is designed as a resistive motion sensor and/or as an inductive motion sensor and/or as a capacitive motion sensor and/or as a magnetic motion sensor.

It is also possible within the scope of the invention that at least one motion sensor is arranged on a printed circuit board. It may also be provided that at least two motion sensors are arranged on a common, i.e., the same circuit board.

Furthermore, it is possible that a detection system may include at least one device to carry out an inventive method, in particular at least one microcontroller and/or at least one processor.

It may also be provided within the scope of the invention that the detection system comprises more than three motion sensors, in particular at least four, at least five or at least six motion sensors.

It is also possible within the scope of the present invention that the detection system includes at least one wake-up sensor. It may also be provided that the power supply of the detection system can be controlled in such a way that a power supply to the wake-up sensor is maintained, while the power supply of at least one motion sensor is interrupted, at least temporarily. Furthermore, it can be provided that a movement of the movable component can be detected by the wake-up sensor. If a movement of the movable component has been detected, the power supply of at least one motion sensor, in particular of all motion sensors, can be established in order to enable continuous detection of the current angle of rotation or the current position of the movable component. This has the advantage that the energy consumption of the detection system is reduced, at least temporarily, without jeopardizing the continuous detection of the current position or the current angle of rotation of the movable component.

It may also be provided for the detection system to include at least one control unit. It may be provided that the control unit is in active connection with at least one motion sensor in such a way that an energy supply to the motion sensor can be interrupted or established, at least temporarily. It may also be provided that the control unit is in active connection with at least one wake-up sensor of the detection system in such a way that, as a function of a signal received by the wake-up sensor (wake-up signal), the power supply of at least one motion sensor can be established.

Further, the above object is achieved by a vehicle, comprising at least one inventive detection system or at least one detection system. With regard to the vehicle, there are the same advantages as those already described with regard to an inventive detection system and an inventive method.

Further, the above object is achieved by a computer program product, comprising commands that cause an inventive detection system or a detection system to execute an inventive method or a method. With regard to the computer program product, the same advantages result as those already described with regard to an inventive detection system and an inventive method.

Furthermore, the above object is achieved by a computer-readable storage medium on which an inventive computer program product or a computer program product is stored. With regard to the computer-readable storage medium, the same advantages result as those already described with regard to an inventive computer program product.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of an inventive detection system,

FIG. 2 shows a schematic view of an inventive method,

FIG. 3 shows a schematic view of an output signal to a motion sensor,

FIG. 4 shows a schematic view of an output signal to a motion sensor and

FIG. 5 shows a schematic view of an inventive vehicle.

### DETAILED DESCRIPTION

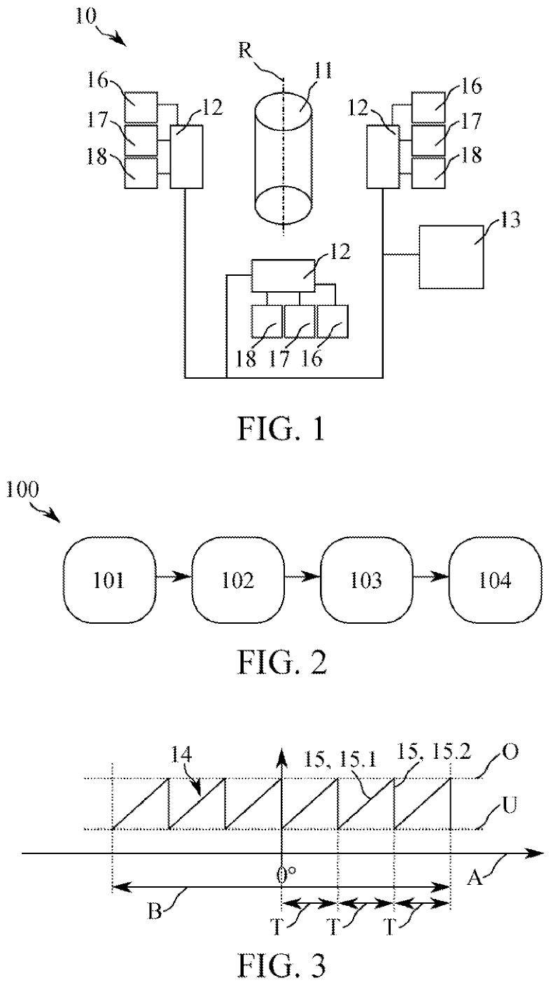

FIG. 1 shows a schematic view of an inventive detection system 10. The detection system 10 comprises at least three partially incremental motion sensors 12, wherein the motion sensors 12 are designed as rotation angle sensors for the redundant detection of the angle of rotation A of a movable component 11. In the present case, the movable component 11 is at least rotationally mounted, wherein a rotation of the component 11 about the axis of rotation R is possible. The rotationally mounted component 11 is mounted in such a way that a rotation can be carried out from a reference position (zero position) both clockwise and counterclockwise about the axis of rotation R. The permissible range of motion (angle of rotation) of the movable component 11 covers more than one complete rotation of the rotationally mounted component 11 about the rotation axis R and is thus more than 360° (angular degrees).

The motion sensors 12 are designed as partially incremental rotation angle sensors and enable a continuous or quasi-continuous detection of the rotation angle A of the movable component 11 via a measuring segment T detectable by the motion sensors 12. At least when the angle of rotation A of the movable component 11 and monitored by the partially incremental motion sensor 12 exceeds or undercuts the upper or lower limit value of the measuring segment T, an increment counter 16 assigned to the motion sensor 12 is incremented or decremented, and the measuring segment T of the motion sensor 12 is passed through again accordingly as the movable component 11 rotates progressively. In this case, the increment counter 16 is incremented or decremented depending on whether it falls below or reaches the lower limit value U and whether it exceeds or reaches the upper limit value O of the measuring segment detectable by the motion sensor 12. For example, when the upper limit value O is reached or exceeded, the increment counter is incremented, and when the limit value U is reached or undercut, the increment counter is decremented.

In addition, the detection system 10 includes at least one non-volatile data memory 13 in order to be able to permanently store or save at least one rotation angle sensor data record and/or at least one error data record. The use of a non-volatile data memory offers the advantage that the data are preserved even if the power supply to the detection system is lost.

Furthermore, the detection system 10 comprises at least three brown-out detectors 17, wherein at least one brown-out detector 17 is assigned to each of the angle rotation sensors 12, so that a supply voltage of the corresponding rotation angle sensor 12 can be monitored or a loss of the supply voltage of the corresponding rotation angle sensor 12 can be detected via each of the brown-out detectors 17. This has the advantage that a loss of information can be effectively avoided in the event of a loss of a supply voltage or power supply and that safe and correct operation of the detection system 10 can be resumed after the voltage supply or power supply has been restored.

The motion sensors 12 are powered by different independent energy sources 18, which can increase the reliability of the detection system 10.

FIG. 1 shows the detection system 10 purely schematically. In particular, at least two motion sensors 12 may be located on a common printed circuit board. Furthermore, at least one brown-out detector 17 may be at least partially designed as an electrical circuit, in particular as a brown-out detection circuit.

FIG. 2 further shows a schematic view of an inventive method 100 for the operation of at least one detection system 10 for the detection of a, in particular current, rotation angle A and/or a, in particular current, position of a movable component 11, the detection system 10 comprising at least three, in particular partially incremental motion sensors 12 for independent and/or redundant monitoring of the movable component 11 and at least one non-volatile data memory 13, wherein for each motion sensor 12 at least the following steps are taken: (a) Evaluating 101 an output signal 14 of the respective motion sensor and detecting that the output signal 14 has at least once undercut or reached a lower limit value U and exceeded or reached an upper limit value O, wherein the lower limit value U and the upper limit value O demarcate a measuring segment T detectable by the motion sensor 12; (b) Incrementing or decrementing 102 of an increment counter 16 assigned to the respective motion sensor 12 at least when the output signal 14 has been detected to fall below or reach the lower limit value U or to exceed or reach the upper limit value O, wherein in addition, the following step is performed: (c) Retrieving 104 and comparing the counter readings of the increment counters 16 assigned to the motion sensors 12 to detect an erroneous counter reading of at least one increment counter 16.

Also, for each motion sensor 12, the following step is also performed: retrieving 103 the counter reading of the increment counter 16 and storing at least one motion sensor data record in the non-volatile memory 13, wherein the motion sensor data record includes at least the current value of the increment counter 16 and a motion sensor identifier of the respective motion sensor 12.

FIG. 3 shows a schematic view of an output signal 14 of a motion sensor 12, wherein the motion sensor 12 is designed as a rotation angle sensor. The output signal 14 generated by the motion sensor 12 over the entire permissible range of motion B of a rotationally mounted component 11 is represented, wherein a movement or rotation of the component 11 beyond the limits of the range of motion B is not possible.

Starting from a reference position (0°), the component 11 can be rotated one full rotation of 360° (angular degrees) clockwise and one full rotation of 360° (angular degrees) counterclockwise, so that the range of motion includes a total of two complete revolutions (720°).

FIG. 3 shows that the output signal 14 of the motion sensor 12 has a sawtooth structure or a sawtooth-shaped profile. Here, each sawtooth represents the complete or one-time passage through the measuring segment T detectable by the motion sensor 12.

In the present case, the measuring range of the measuring segment T is 120° (angular degree), so that a complete revolution of the movable component 11 is shown in the output signal by a total of three saw teeth. The saw teeth are lined up according to a progressive rotation of the component 11.

In the present case, the amplitude or value of the output signal 14 is plotted above the motion detected by the motion sensor 12 (in this case a rotation of the component 11). Each sawtooth 15 of the output signal 14 has a first flank 15.1 with a finite slope and a second flank 15.2 with an infinite slope, wherein the slope represents the change in the output signal 14 with respect to the change in the angle of rotation A detected by the motion sensor 12.

The first flank 15.1 characterizes a continuous increase or decrease of the output signal 14 of the motion sensor 12 while the measuring segment T detectable by the motion sensor 12 or a progressive rotation of the component 11 in the measuring segment T is traversed. The value of the output signal 14 is proportional to the measured value or rotation angle or displacement currently recorded in the measuring segment T of the motion sensor 12. The second flank 15.2 characterizes the transition from one (e.g., first) traversal of the measuring segment T detectable by the motion sensor 12 to a new (e.g., second) passage through the measuring segment T detectable by the motion sensor 12 and thus a necessary incrementing of the increment counter 16 assigned to the motion sensor 12.

The output signal 14 shown in FIG. 3 can be evaluated to determine whether the output signal reaches or exceeds the upper limit value O and/or whether it reaches or falls below the lower limit value U, because in both cases the measuring segment T of the motion sensor 12 would be traversed again and thus incrementing of an increment counter 16 assigned to the motion sensor 12 is necessary in order to continuously record the correct position or the correct angle of rotation A of the movable component 11. In this case, the upper limit value O and the lower limit value U demarcate the measuring segment T detectable by the motion sensor 12, such that the value of the output signal 14 of the motion sensor 12 can only ever move between the upper limit value O and the lower limit value U.

If it was detected that the upper limit value O has been reached or exceeded and/or the lower limit value U has been undercut or reached and/or a change from a first sawtooth 15 to a second sawtooth 15, the increment counter 16 associated with the motion sensor 12 is incremented. Depending on the determined direction of movement (e.g., clockwise or counterclockwise rotation) of component 11, the increment counter 16 can be incremented in correspondingly opposite directions.

For example, the current rotation angle A of a movable component 11 monitored by the motion sensor 12, which is recorded by the partially incremental motion sensor 12, can be determined by multiplying the counter reading of the increment counter 16 assigned to the motion sensor 12 by the measuring range covered by the measuring segment T of the motion sensor (in this case 12°) and then adding it to the value readable or determinable from the output signal 14 of the motion sensor 12 within the measuring segment T detectable by the motion sensor 12.

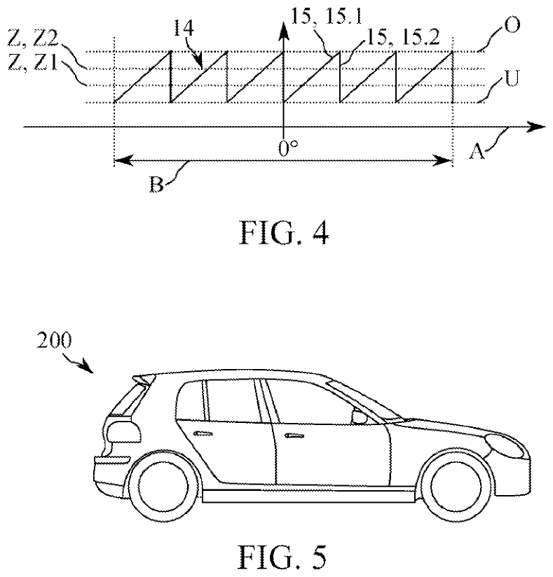

FIG. 4 shows a schematic view of an output signal 14 of a motion sensor 12, wherein the output signal 14 corresponds to that of FIG. 3. In addition, however, FIG. 4 shows two intermediate limit values Z. The first intermediate limit value Z1 is lower than the second intermediate limit value Z2. In addition, the first intermediate limit value Z1 and the second intermediate limit value Z2 are greater than the lower limit U and lower than the upper limit value O. The first intermediate limit value Z1 and the second intermediate limit value Z2 divide the range of values between the upper limit value O and the lower limit value U into equidistant distances.

In addition to the incrementing of a motion sensor 12 already explained in relation to FIG. 3, if the output signal reaches or exceeds the upper limit value O or reaches or falls below the lower limit value U, the increment counter 16 assigned to the motion sensor 12 is also incremented, with reference to FIG. 4, if one of the intermediate values Z is exceeded or undercut or reached. Depending on the current direction of movement of the component 11, the increment counter 16 is also incremented in the opposite directions. By means of such a counting method, the prerequisite for a more accurate evaluation of the motion sensor 12 or the counter reading of the increment counter 16 assigned to the motion sensor 12 can be created.

The reason for this is that, with respect to the second flank 15.2 of a sawtooth, there may be an ambiguity in the output signal 14, since a first counter reading of an increment counter 16 in combination with a value of the output signal 14 which corresponds to the upper limit value O (upper end of the second flank 15.2) characterizes the same angle of rotation A as a counter reading incremented by (plus) one in combination with a value of the output signal 14 which corresponds to the lower limit value U (lower end of the second flank 15.2). However, an isolated observation of the counter readings that differ by one can lead to an incorrect interpretation and thus to a false detection of an error in the detection system 10. This can be avoided by additional incrementing of the increment counter 16 at the intermediate limit values Z and a correspondingly adapted evaluation of the counter readings.

With reference to FIG. 3, assuming a counter reading of zero at the zero position (0°) of the increment counter 16 assigned to the motion sensor 12, a counter reading of three is obtained at the tip of the first sawtooth 15 in the direction of the angle of rotation A and the upper end of the corresponding second flank 15.2, since the increment counter 16 was incremented with (plus) one in each case when the first and second intermediate limit values Z2 and the upper limit value O were reached or exceeded. At the lower end of the second flank 15.2 or the start of the following sawtooth 15, the counter reading of the increment counter 16 is four since a renewed incrementing was carried out when the lower limit value U was reached. An evaluation of these counter readings on the basis of a direct comparison would thus result in the detection of an error.

If, however, both counter readings are increased by one in the evaluation and then a division without remainder is performed by the intermediate limit values Z increased by one, a counter reading of three will result in a result of 1 and a counter reading of four will also result in a result of 1. Accordingly, in the context of an evaluation of the counter readings, both (different) counter readings would be evaluated as equivalent and thus correct. The adapted evaluation can thus prevent incorrect detection of errors in the detection system 10.

FIG. 5 further shows an inventive vehicle 200 comprising at least one inventive detection system 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a detection system for detecting a current position or current angle of rotation of a movable component, the detection system comprising at least three partially incremental motion sensors for redundant monitoring of the movable component, the method comprising for each motion sensor:
a) evaluating an output signal of the respective motion sensor, which output signal has detected that the output signal falls below or reaches at least one lower limit value and exceeds or reaches an upper limit value, the lower limit value and the upper limit value demarcating a measuring segment detectable by the motion sensor;
b) incrementing or decrementing an increment counter assigned to the respective motion sensor at least when the output signal has detected that the output signal falls below or reaches the lower limit value or that it exceeds or reaches the upper limit value; and
c) retrieving and comparing the counter readings of the increment counters assigned to the motion sensors in order to detect an erroneous counter reading of at least one increment counter.

2. The method according to claim 1, wherein, in step c), at least one of the following steps is performed:
carrying out at least one majority decision or at least one 2-out-of-3 decision for an identification of at least one erroneous counter reading;
correcting an erroneous counter reading of at least one increment counter; and/or
storing at least one error data record in the non-volatile memory.

3. The method according to claim 1, wherein the detection system comprises at least one non-volatile data memory and wherein at least the following step is carried out for each motion sensor at least at fixed time intervals and/or at least after each execution of step (b) and/or at least in an event of a loss of supply voltage of at least one motion sensor:
retrieving the counter reading of the increment counter and storing at least one motion sensor data record in a non-volatile data memory, wherein the motion sensor data record includes at least the current counter reading of the increment counter and a motion sensor identifier of the respective motion sensor.

4. The method according to claim 1, wherein, for each motion sensor prior to step (a), at least the following step is performed: initializing an increment counter with an initial counter reading and assigning the increment counter to the respective motion sensor.

5. The method according to claim 1, wherein, for each motion sensor, at least the following step is performed or continuously performed: monitoring the supply voltage of the respective motion sensor by at least one brown-out detector for the detection of at least a temporary loss of the supply voltage of the motion sensor.

6. The method according to claim 1, wherein step (b) is additionally carried out at least when the output signal exceeds or falls below at least one first intermediate limit value or a second intermediate limit value, wherein the first intermediate limit value is lower than the second intermediate limit value and the first intermediate limit value and the second intermediate limit value are greater than the lower limit value and lower than the upper limit value.

7. The method according to claim 6, wherein in step (c), prior to comparing the counter readings, the counter reading of at least one increment counter is corrected, wherein at least the following arithmetic operations are carried out to correct the counter reading:
calculating a dividend by increasing the counter reading by one;
calculating a divisor by increasing the number of intermediate limit values by one;
performing a division with no remainder using the dividend and divisor.

8. A detection system comprising:
at least three partially incremental motion sensors for redundant detection of a current position or current angle of rotation of a movable component; and
at least one non-volatile data memory,
wherein the detection system is operated according to the method according to claim 1.

9. The detection system according to claim 8, wherein at least two motion sensors are operated by different and/or independent energy source.

10. The detection system according to claim 8, wherein at least two motion sensors have a spatial offset.

11. The detection system according to claim 8, wherein at least one brown-out detector is included, with which the supply voltage of at least one motion sensor is monitored and/or a loss of supply voltage is detected.

12. The detection system according to claim 8, wherein the detection system further compres at least one microcontroller and/or at least one processor.

13. A vehicle comprising at least one detection system according to claim 8.

14. A computer program product, comprising commands which cause a detection system to perform the method according to claim 1.

15. A computer-readable storage medium on which the computer program product according to claim 14 is stored.
